(19) United States
(12) Patent Application Publication
(10) Pub. No.: US 2010/0096813 A1
(43) Pub. Date: Apr. 22, 2010

(54) CHUCKING END STRUCTURE OF HAND TOOLS

(75) Inventor: Peter CHEN, Taoyuan County (TW)

Correspondence Address: Muncy, Geissler, Olds & Lowe, PLLC, P.O. BOX 1364, FAIRFAX, VA, 22038-1364, US

(73) Assignee: PRIMETOOL MFG, INC.

(21) Appl. No.: 12/255,331

(22) Filed: Oct. 21, 2008

(51) Int. Cl. B23B 31/30

(52) U.S. Cl. 279/4.04

(57) ABSTRACT

A chucking end structure of hand tools to enhance safety and overcome hard-maneuvering issues of the conventional structures. The invention includes a driving means to provide rotating energy and a chuck assembly to hold a cutter or a tool. The foregoing means and assembly are linked by a transmission shaft to transmit rotation. The transmission shaft is held in a holding hub which is engaged with a casing to house the driving means. The character of the invention is that a hollow shell to encase but not contact the chuck assembly. The transmission shaft comprises a first transmission shaft and a second transmission shaft which mortise with each other by a lug end and a notch end with a sloped side. The invention resolves problems of hard-maneuvering issues or hazards caused by inadvertently touching the rotating chuck assembly of the conventional hand tools.

### FIELD OF THE INVENTION

The present invention is a chucking end structure of hand tools and particularly to a structure that provides precise maneuvering of a hand tool and enhances safety.

### BACKGROUND OF THE INVENTION

With development of technology, electric and pneumatic driven techniques are well developed. Hand tools also adopt the aforesaid techniques to develop various structures and multi-functions. The structures of hand tools mostly have a transmission shaft driven and rotated by electric power or pressurized air. The transmission shaft has one end coupling with different types of cutters or tools such as Philips head tips, slotted tips, or grinding wheels, cutting wheels, engraving wheels to meet different work requirements.

For instance, R.O.C. patent publication No. 200744805 entitled “Storable hand tool equipped with a handheld power machinery” has a driving mechanism to rotate a front chucking end which has a chuck assembly to hold a cutter or a tool. However, the chuck assembly is exposed and has to be spaced from the handgrip at a distance to prevent faulty operation or hurting people. Keeping such a distance also makes control and maneuvering of the tool difficult and inaccurate. As a result, the cutter or the tool is prone to spring away in high speed rotation and torsion conditions. Sprung pieces could break something, or even hurt operators. It goes without saying how dangerous the hand tool is. Other reference of hand tools can be found in R.O.C. patent publication Nos. 1232155, 443197 and 346856 that disclose respectively “Transmission shaft and adapter for rapid removing/installing tools”, “Pneumatic tool kit” and “Chuck apparatus for engraving machines and handle structure of grinding elements”. They also have an exposed chuck assembly which has to be spaced from the handgrip. Hence they all leave a lot to be desired in terms of maneuverability and safety. Therefore, the conventional chucking end structures of hand tools are still have rooms for improvement.

### SUMMARY OF THE INVENTION

In view of the conventional hand tools having an exposed chuck assembly at the chucking end that is spaced from the handgrip and results in difficult and inaccurate maneuvering, the primary object of the present invention is to provide a chucking end that can be gripped at a shorter distance to overcome the aforesaid problems occurred to the conventional techniques.

To achieve the foregoing object the present invention includes a driving means to provide rotational energy and a chuck assembly to couple with a cutter or a tool. The driving means and the chuck assembly are linked by a transmission shaft to form rotational transmission therebetween. The transmission shaft is held in a holding hub. The holding hub is engaged with a casing which encases the driving means. The present invention provides other features as follow: the chuck assembly is encased in a hollow shell without in contact with each other. The shell covers the chuck assembly and remains stationary. The transmission shaft has a first transmission shaft and a second transmission shaft. These two transmission shafts mortise with each other by a lug end and a notch end which has an arched edge and is shrunk gradually inwards from the edge.

By means of the construction set forth above, the present invention provides many advantages over the conventional techniques, notably:
1. With the chuck assembly fully covered by the shell, accidents caused by inadvertent touching other objects during rotation can be avoided.
2. With the chuck assembly encased in the shell, the shell can be directly gripped without touching the chuck assembly. Maneuvering of the hand tool is easier and more precise.
3. The lug can be easily wedged in the arched and tapered notch to quickly couple the first transmission shaft and the second transmission shaft together.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is another exploded view of the invention.

FIG. 4A is a sectional view of the invention.

FIG. 4B is another sectional view of the invention.

### DETAILED DESCRIPTION OF THE PREFERRED EMBODIMENT

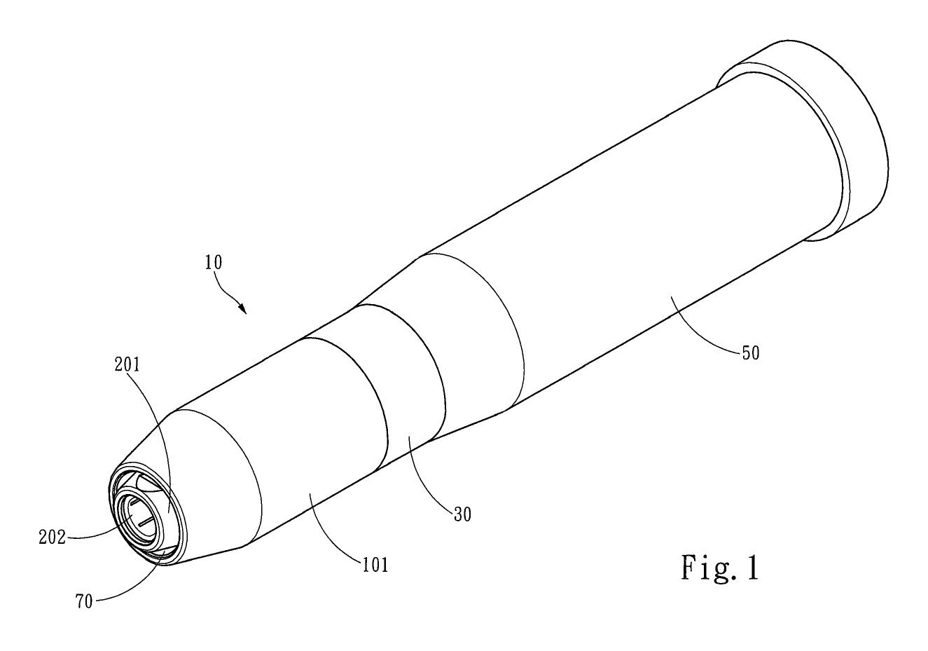

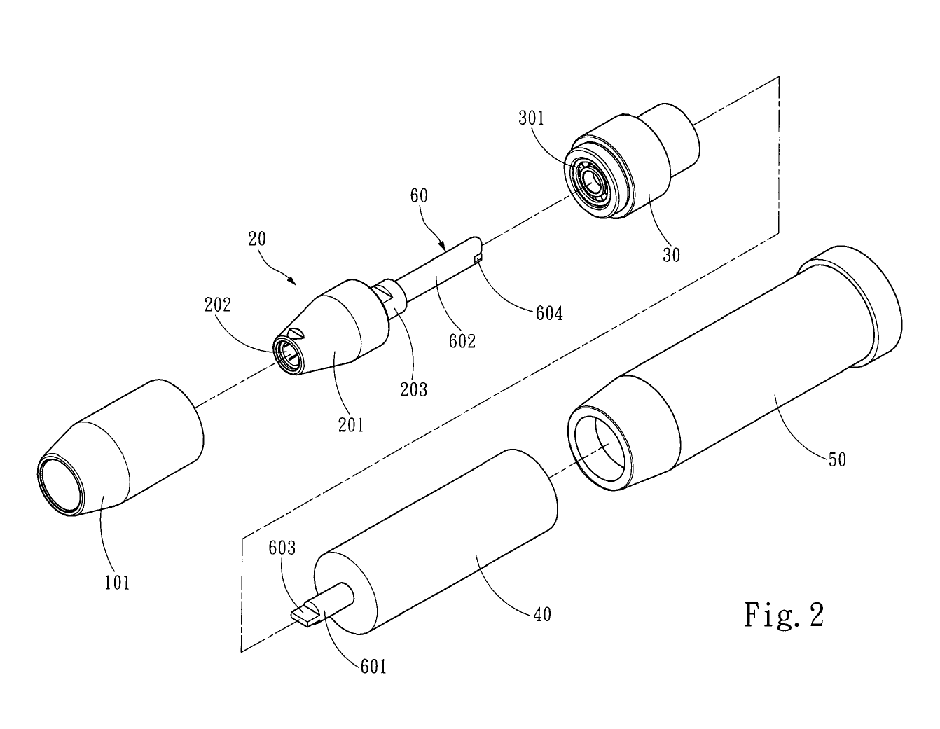

Please referring to FIGS. 1, 2 and 3, the present invention includes a driving means 40 and a chuck assembly 20 to hold a cutter or a tool. The driving means 40 and the chuck assembly 20 are linked by a transmission shaft 60 so that rotational driving power output from the driving means 40 can be transmitted to the chuck assembly 20. The transmission shaft 60 is held steadily in a holding hub 30 without shaking or skewing while it is driven by the driving means 40 during rotation. The present invention further provides other features as follow: a hollow shell 101 is provided to couple with the holding hub 30 and encase the chuck assembly 20. The shell 101 is spaced from the chuck assembly 20 at a gap 70 without in contact with each other. The transmission shaft 60 includes a first transmission shaft 601 connecting to the driving means 40 and a second transmission shaft 602 connecting to a rotary dock 203 of the chuck assembly 20. The first transmission shaft 601 and the second transmission shaft 602 have respectively one end formed a lug 603 and a notch 604 which has an arched edge and is shrunk gradually inwards from the edge. Such a structure allows the chucking end to be gripped directly to enhance maneuverability and safety.

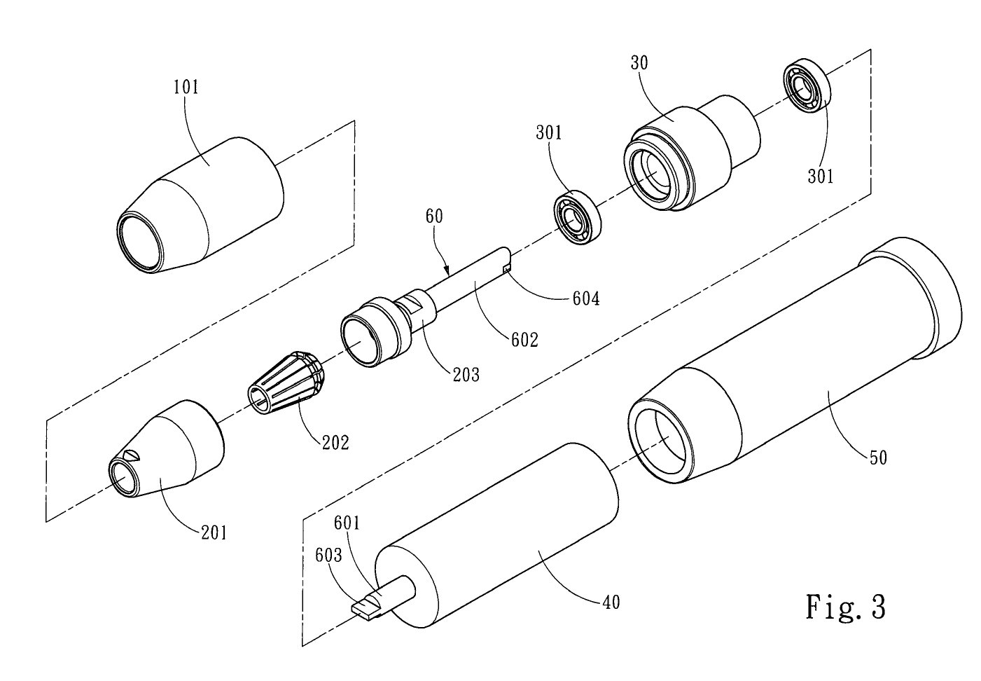

In addition, the chuck assembly 20 has a chuck 202 to hold the cutter or the tool, a rotary dock 203 to hold the chuck 202 and a fastening hood 201. The fastening hood 201 is hollow to contract and squeeze the chuck 202, and fastened to the rotary dock 203. Referring to FIG. 3, the chuck 202 is conical and has a plurality of jaws arranged in an annular manner and spaced from each other. Before the chuck 202 is contracted and squeezed by the fastening hood 201, the jaws are spaced from each other loosely to allow the cutter or the tool to be inserted or removed. After the fastening hood 201 is engaged with the rotary dock 203 and squeeze the chuck 202, the spaces between the jaws are contracted to clamp the cutter or the tool tightly. And the fastening hood 201 and the rotary dock 203 can be fastened firmly. Thus the chuck assembly 20 can firmly hold the cutter or the tool. The holding hub 30 has at least one bearing 301. It can be an independent element or integrally formed with a casing 50. The first transmission shaft 601 and second transmission shaft 602 can be coupled easily through the lug 603 and notch 604. The positions of the lug 603 and notch 604 may also be switched and formed respectively on the second and first transmission shafts 602 and 601. Either approach can provide a firm coupling. The driving means 40 may be an electrical driving means or a pneumatic one.

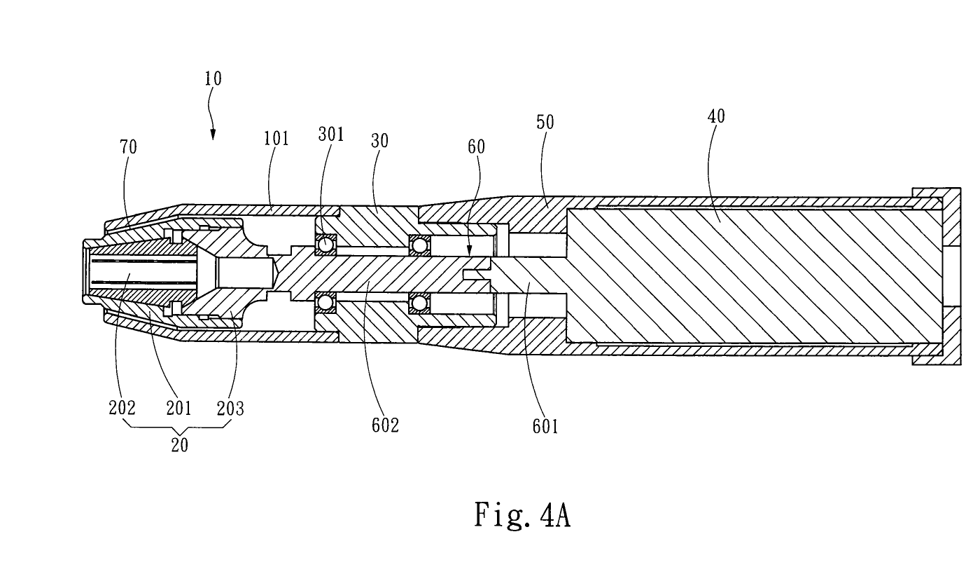

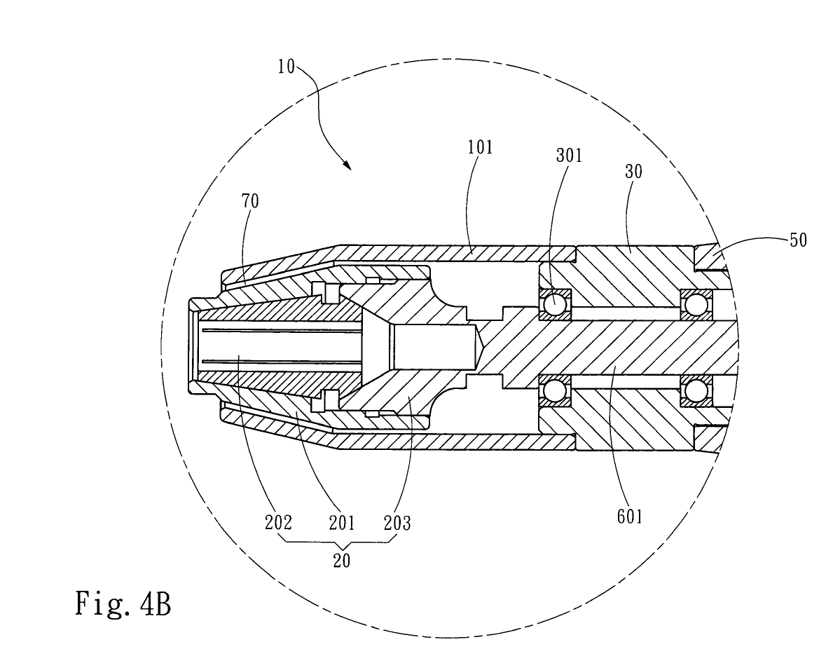

Referring to FIGS. 4A and 4B, for assembly of the present invention, first, detach the casing 50 and install the driving means 40 before the assembly is started; next, mount the casing 50 to extend the first transmission shaft 601 outside the casing 50; dispose the holding hub 30 to couple on the first transmission shaft 601 and engage with the casing 50; insert the second transmission shaft 602 into the holding hub 30 to nudge and engage the lug 603 with the notch 604 to form coupling between them; finally encase the shell 101 over the chuck assembly 20 to engage with the holding hub 30. The assembly is finished with not cutter or tool held thereon. To couple with a cutter or a tool, remove the shell 101 and fastening hood 201; insert the cutter or tool in the chuck 202; couple the fastening hood 201 on the chuck 202 from outside (the cutter or tool may also be inserted by adjusting the clamping tightness of the fastening hood 201 on the chuck 202 without removing the fastening hood 201); contract the chuck 202 by moving the fastening hood 201 towards the rotary dock 203 to tightly clamp the cutter or the tool; then fasten the fastening hood 201 to the rotary dock 203. After having confirmed that the cutter or tool is held firmly in the chuck assembly 20, couple the shell 101 on the chuck assembly 20 to engage with the holding hub 30 so that the shell 101 covers the chuck assembly 20 with only the clamped cutter or tool exposed. Then the hand tool can be started. The driving means 40 outputs rotational energy through the transmission shaft 60 held on the holding hub 30 through the bearing 301. The holding hub 30 remains in a still condition. With the gap 70 formed between the shell 101 and the chuck assembly 20, and the shell 101 fastened to the holding hub 30, the hub 101, holding hub 30 and casing 50 are coupled together and remain stationary. Thus the shell 101 can be gripped directly and firmly, and the hand tool can be maneuvered to do work as desired.

While the preferred embodiment of the present invention has been set forth for the purpose of disclosure, modifications of the disclosed embodiment of the present invention as well as other embodiments thereof may occur to those skilled in the art. Accordingly, the appended claims are intended to cover all embodiments which do not depart from the spirit and scope of the present invention.

What is claimed is:

1. A chucking end structure of hand tools, comprising a driving means and a chuck assembly to hold a cutter or a tool, the driving means and the chuck assembly are linked by a transmission shaft to transmit rotation therebetween, the transmission shaft is held in a holding hub which is engaged with a casing to house the driving means, wherein:
the holding hub is engaged with a hollow shell which encases the chuck assembly and is spaced from the chuck assembly at a gap without contacting with each other; and
the transmission shaft has a first transmission shaft connecting to the driving means and a second transmission shaft connecting to the chuck assembly, the first transmission shaft and the second transmission shaft mortise with each other by a end with a lug and a notch end, the notch having an arched edge and being gradually shrunk inwards from the edge.

2. The chucking end structure of hand tools of claim 1, wherein the chuck assembly includes a chuck to hold the cutter or the tool, a rotary dock to hold the chuck and a hollow fastening hood to wrap and restraint the chuck and fasten down the rotary dock.

3. The chucking end structure of hand tools of claim 1, wherein the holding hub has at least one bearing.

4. The chucking end structure of hand tools of claim 3, wherein the holding hub is integrally formed with the casing.

5. The chucking end structure of hand tools of claim 3, wherein the driving means is selectively a pneumatic driving means or an electrical driving means.

6. The chucking end structure of hand tools of claim 2, wherein the holding hub has at least one bearing.

7. The chucking end structure of hand tools of claim 6, wherein the holding hub is integrally formed with the casing.

8. The chucking end structure of hand tools of claim 6, wherein the driving means is selectively a pneumatic driving means or an electrical driving means.

9. The chucking end structure of hand tools of claim 2, wherein the chuck is conical and has a plurality of jaws arranged in an annular manner and spaced from each other.

10. The chucking end structure of hand tools of claim 9, wherein the holding hub has at least one bearing.

11. The chucking end structure of hand tools of claim 10, wherein the holding hub is integrally formed with the casing.

12. The chucking end structure of hand tools of claim 10, wherein the driving means is selectively a pneumatic driving means or an electrical driving means.
